(19) United States
(12) Patent Application Publication
(10) Pub. No.: US 2005/0166143 A1
(43) Pub. Date: Jul. 28, 2005

(54) System and method for collection and conversion of document sets and related metadata to a plurality of document/metadata subsets

(76) Inventor: David Howell, Seattle, WA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/763,642

(22) Filed: Jan. 22, 2004

(51) Int. Cl. G06F 17/00

(52) U.S. Cl. 715/523; 715/511

(57) ABSTRACT

The system and method for collecting and converting documents sets and related metadata accepts a file or set of files that represent the content of a work and collects and manages metadata associated with that work. The system then automatically converts the work into a variety of different output formats, including embedding or attaching necessary metadata, and distributes it to other internal or external organizations (like wholesalers or retailers) along with any further metadata required by the recipient organization.

### FIELD OF THE INVENTION

The invention relates generally to a document publishing system and in particular to a computer-implemented system electronic document publication and distribution system.

### BACKGROUND OF THE INVENTION

In general, document publishing systems are well known, but suffer from various limitations. For example, most systems output in a proprietary format or limited number of formats, requiring further conversion or processing in order to maximize the utility of the document processed. Most provide little or no support for metadata. Most are not extensible. None have support for comprehensive management and application of metadata to control conversion and distribution of the work.

Thus, it is desirable to provide a system and method for collection and conversion of document sets and related metadata to a plurality of document/metadata subsets, and it is to this end that the present invention is directed.

### SUMMARY OF THE INVENTION

The work collection and conversion system in accordance with the invention accepts a file or set of files that represent the content of a work, collects and manages metadata associated with that work, automatically converts the work into a variety of different output formats including embedding or attaching necessary metadata, and distributes it to other internal or external organizations (like wholesalers or retailers) along with any further metadata required by the recipient organization.

Thus, in accordance with the invention, a system for collecting and distributing an edition of a work is provided. The system has an input module, a storage device and a conversion module. In more detail, the input module receives an input file in a particular format and has a module that validates the input file and converts the input file into an intermediate format file. The storage device has a storage portion that stores the intermediate format file and a piece of work metadata associated with the input file. The conversion module generates one or more editions of a work having one or more formats wherein the one or more editions of the work are generated based on the intermediate format file and the work metadata.

In accordance with another aspect of the invention, a computer implemented method for collecting and distributing an edition of a work is described. Using the method, an input file in a particular format is received and validated. The input file is then converted into an intermediate format file and one or more editions of a work having one or more formats are generated wherein the one or more editions of the work are generated based on the intermediate format file and a work metadata.

### BRIEF DESCRIPTION OF THE DRAWINGS

FIG. 1 is a block diagram illustrating an overview of a work collection and conversion system in accordance with the invention;

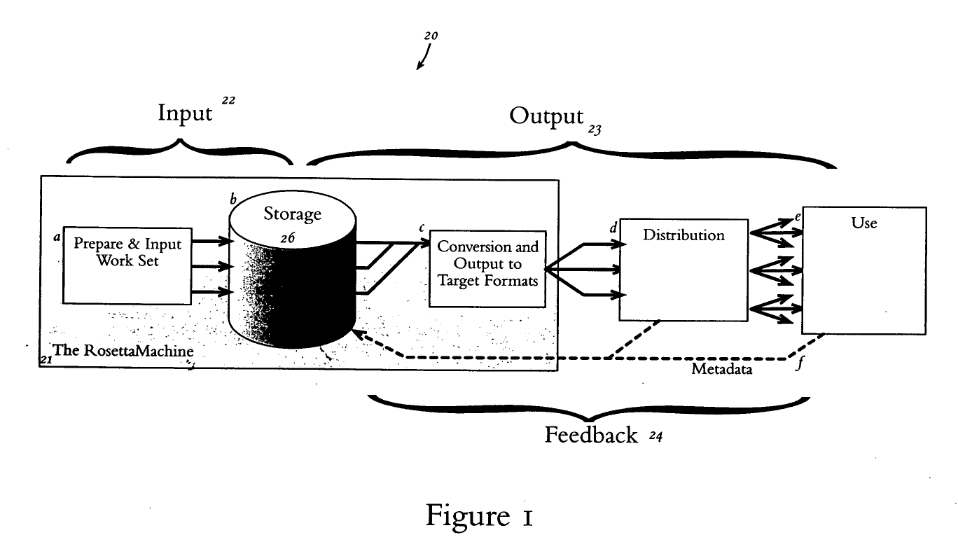

FIG. 2 is an example of an implementation of a preferred embodiment of a work collection and conversion system in accordance with the invention;

FIG. 3 is a flowchart illustrating a method for preparing a work for storage in accordance with the invention;

FIG. 4 illustrates a method for storing a work set in accordance with the invention;

FIG. 5 illustrates a general method for converting a work set in accordance with the invention;

FIGS. 6A and 6B illustrates more details of an exemplary output converter in accordance with the invention;

FIGS. 7A and 7B are illustrating examples of the output conversion process in accordance with the invention;

FIG. 8 illustrates an example of converting a work set into a single output file/format in accordance with the invention;

FIG. 9 illustrates an example of converting a work set into a metadata only in accordance with the invention;

FIG. 10 illustrates an example of converting a work set into a single format with multiple differentiated files in accordance with the invention;

FIG. 11 illustrates an example of an embodiment of the document collection and conversion system in accordance with the invention in a single user local distribution mode;

FIG. 12 illustrates another example of an embodiment of the document collection and conversion system in accordance with the invention in an automatic distribution mode;

FIG. 13 illustrates another example of an embodiment of the document collection and conversion system in accordance with the invention in an on-demand reader-initiated mode; and

FIG. 14 illustrates another example of an embodiment of the document collection and conversion system in accordance with the invention in a BookGalley mode.

### DETAILED DESCRIPTION OF A PREFERRED EMBODIMENT

The invention is particularly applicable to the processing of primarily (although not exclusively) textual information intended to be read or viewed as a self-contained, stand-alone object—an “e-book.” It is in this context that the invention will be described. It will be appreciated, however, that the system and method in accordance with the invention has greater utility, such as to facilitate the printing of paper books from electronic files; creation, conversion and distribution of works whose primary embodiment is not a textual document (like picture books or audio books), or managing the metadata associated with a Work that was not created or converted by the System itself, such as posters or t-shirts.

The system in accordance with the invention accepts a file or files that represent the content of an “e-book” or digital file intended to be used to read primarily textual material and collects and manages metadata associated with that content. The system also automatically converts the content into a variety of different output formats, including embedding or attaching necessary metadata, and distributes the converted content to other organizations (like wholesalers or retailers) along with any further metadata required by the recipient organization. The system may also collect metadata from those organizations about the distributed items.

Prior to describing the system in more detail, an overview of the process will be described. The system receives an input into the system which is a work. A work is a collection of text and images, typically contained within a computer file or set of related computer files, representing information intended to be presented or published as a whole. An edition is a specific presentation or realization of a work. For example, a web site, an Acrobat .pdf file, and a printed book are examples of possible different editions of the same work. The metadata is information about a work, but not necessarily contained within the work itself. Some metadata is intrinsic, such as word count, which can be calculated from the work itself. The extrinsic metadata may include, for example, the identity of the author, the price of the work, its ID code, the author's royalty rate, distribution restrictions, and creation date. The extrinsic metadata cannot be deduced or calculated from the contents of the work. A work set is the combination of a work and its metadata. The RosettaMachine is an example of an implementation of a core conversion engine in accordance with the invention. The RosettaMachine converts a file or related group of files from one of its acceptable source formats to the requested target format. Using the RosettaMachine, the same source file set can be submitted multiple times to prepare a variety of output files.

The Express ePublishing System is a business process/system that guides a publisher through the procedure of preparing an e-book source file (as a Word .doc file, an RTF file, an OEB file, or an XML file), submitting it to the web site of the system, providing the necessary metadata, requesting specific conversion and/or distribution options, and receiving e-book files. An e-book is a work set consisting of textual matter (possibly with other media) intended to be presented as a whole. The e-book may be, for example, a novel, a textbook, an instruction manual, a collection of crossword puzzles, a picture album, or a spoken-word sound file. Although “galley proof” is still the common usage, the publishing industry almost exclusively uses what is more correctly described as “uncorrected page proofs”. A galley proof (or just “proof”) is a copy of a paper book after it has been typeset but before it's been proofread. Traditionally, a galley proof is available six or more months before the publication of a book, and copies of the galley proof are frequently distributed to buyers and reviewers, so that they have enough time to order or review the book and have the review come out as the title is hitting the shelves. When a work it validated, it is examined to ensure that the work is compliant with a specific set of conditions.

In the broadest terms, a work collection and conversion system 20 in accordance with the invention may include at least three processes (one of which is an optional process) that include: an input process 22 in which a work set is prepared and stored, an output process 23 in which a work set is converted and distributed in one or more different formats, and optionally a feedback process 24 in which additional metadata may be collected from user that may be then added to the work set. In more detail, the input process 22 collects (step a) a properly-prepared work and associated Metadata from a source, such as a human being and may perform transformations designed to ‘clean up’ or normalize the work set, and then place the work set into Storage (step b) such as storing the work set into a database 26. The stored work set may remain in storage until a request for an output of the work set is made and the output process 23 occurs. During the output process 23, the work set is converted into a plurality of copies (editions) (step c) that may have different formats (or the same formats), and then distributed (step d) to one or more locations or entities (e). Steps c-e are parts of the output process. In accordance with a preferred embodiment of the invention, steps a-c may be performed by a RosettaMachine 21. In step f, the feedback process 24 occurs in which information related to the work set (and its editions) may be sent from the users back to the system 20 for incorporation into the work set. Each of these steps will be described in more detail below.

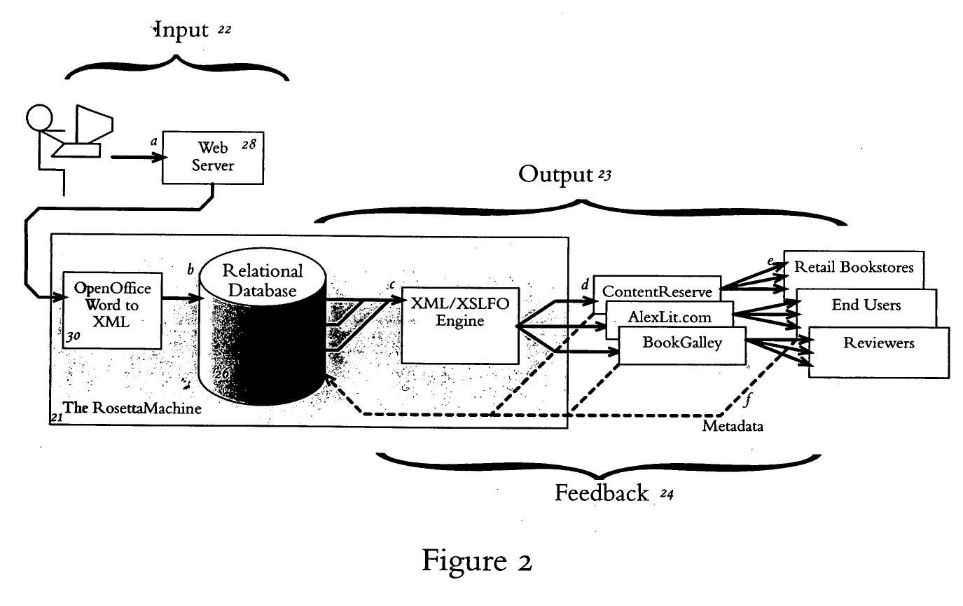

The above system and methodology can be realized in a variety of different implementations that are all within the scope of the invention. FIG. 2 is a diagram illustrating an example of an implementation of the system 20. In this example, the system may be implemented using a web-based computer system implementation wherein the components are housed in a server and user of the system may access the system using the Internet and the World Wide Web and a typical well known browser application. In this example, many of the input, output and feedback functions are performed by one or more pieces of software residing on the server in memory or a persistent storage device (as is well known) that are executed by one or more processor(s) of the server. As is well known, each piece of software may comprise a plurality of lines of instructions that cause various functions to be performed.

As shown in FIG. 2, a person (operating a typical computer system such as a personal computer with typical components) may operate a typical computer program, such as a word processor (e.g. Microsoft Word™) to create a file or retrieve a file from another location and then upload that file to a web server 28 using well known techniques. The web server may store a known OpenOffice application 30 (stored on the web server and executed by the web server) and use it to read the Word file, and save it out as an XML file. This is the input and normalize steps that were discussed above although the invention is not limited to these particular input and normalize steps. The XML file, in this example, is then stored in the database 26 which may be a known relational database in this example. Upon demand, conversion may occur. In this example of an implementation of the system, the conversion may occur with a piece of software comprising a plurality of lines of code that may perform an XSLFO transformation (step c) from the stored XML work set to a target XML file. The target XML file may then be distributed (step d) by various electronic means, such as email, FTP, or HTTP transfer, to corporations like e.g. ContentReserve or R. R. Bowker, as well as to internal sites (e.g. AlexLit.com, BookGalley.com). Thus, the file may be distributed to various entities by various means that are all within the scope of the invention. As a result of the distribution, copies of the file thus become available (step e) to end users (e.g. bookstores, reviewers, readers), some of whom might then report back feedback data, including but not limited to sales figures, reviews, or ratings, in step f. Now, a method for preparing a work for storage in accordance with the invention will be described in more detail.

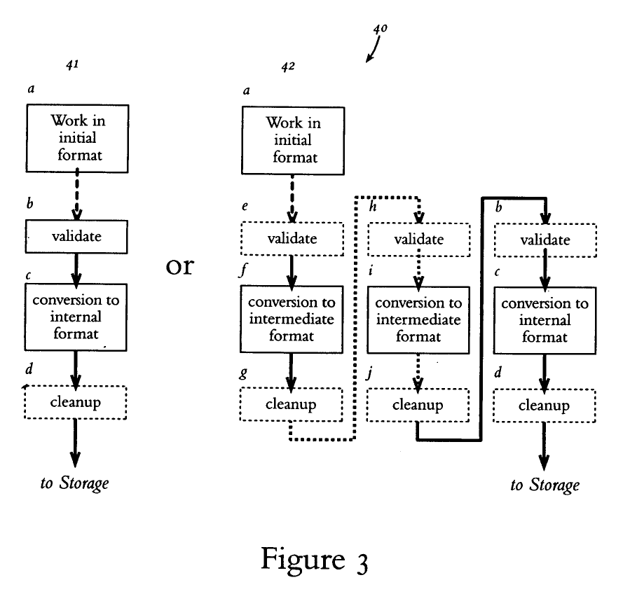

FIG. 3 illustrates a method 40 for preparing a work for storage in accordance with the invention. The difficulty of preparing a work for storage will vary depending on how well the work was prepared before it reaches the system 20. A process 41 illustrates the method for a well prepared document with process 42 illustrates the method for a poorly prepared work. Thus, for a properly formatted work, the work is received in an initial format (step 41a) and may be validated (step 41b). In step 41c, the work is converted to an internal representation format (e.g. tokenizing, compression, or replacing duplicate components with references), and, in step 41d, an optional final “clean-up” step may be performed. In process 42, the same steps described above may occur, but a more poorly formatted work might require one or more other intermediate steps (steps 42h-j and 42e-g) before being converted to a standard internal format. Now, a process for storing a work into the system will be described in more detail.

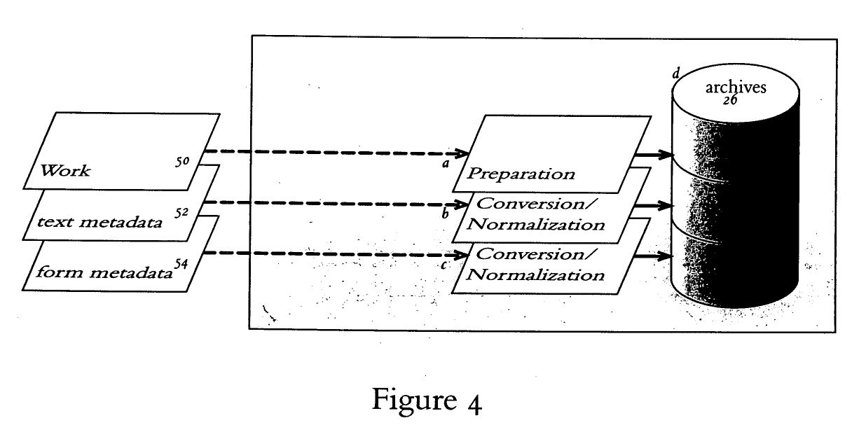

FIG. 4 illustrates a technique for storing a work into the storage of the system. The storing of a work 50 in the system requires the gathering of the metadata associated with the work, such as text metadata 52 and form metadata 54, in order to form a work set. The work itself is prepared (step a) as described above. The work metadata, which is metadata related to the work itself and metadata related to the final forms that the Work might assume (form metadata) are collected and converted (e.g. by removing extraneous punctuation from numbers, applying consistent capitalization rules, and/or mapping to an XML schema) in steps b and c. In step d, the work and its associated metadata are then placed in the storage system 26 (e.g. a database, hard drive file system, or tape library archive), forming a work set. Once the work set has been stored into the system, the work set is available for conversion to different formats as will now be described.

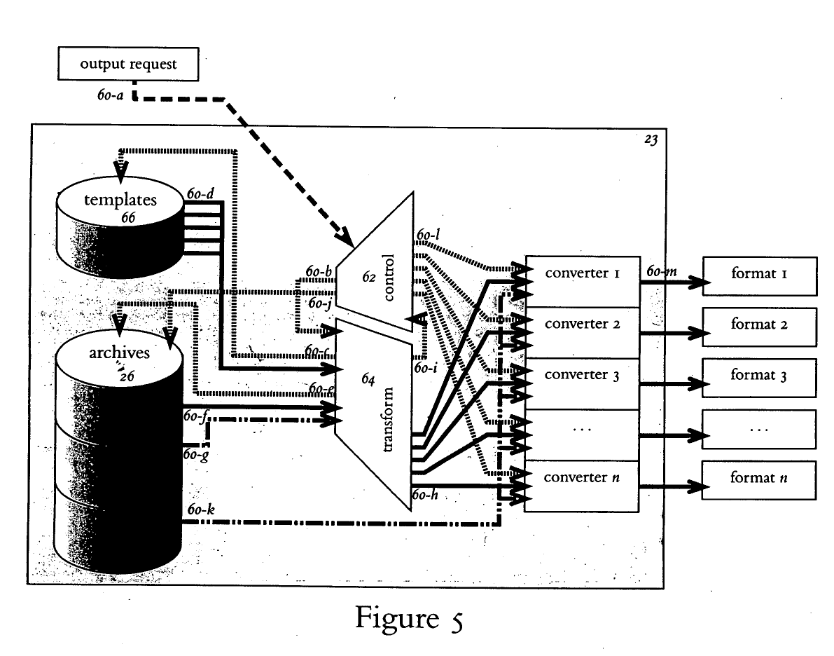

FIG. 5 is a diagram illustrating more details of the conversion and output process 23 in accordance with the invention. The conversion and output process starts when an output request is received (Step 60a). The request may specify a work or works to be processed, which of various available “style sheet” options should be used, and in which format or formats it should be output. The request might also include request-specific metadata information. The conversion and transformation of the work may be performed by a control system 62 and a transform module 64 which are both pieces of software that together control and perform the conversion operations of the system.

The control system 62 receives the output request and passes the work and format information to the transform module 64 (Step 60b). The transform module will request (Step 60c) and retrieve (Step 60d) style sheet templates and transform matrix templates from the template storage system 66 (that may be stored in the same database as the work or in a separate database). In step 60e, the transform module 64 may request and receive (Step 60f) the work(s) to be output from the archives 26, as well as the appropriate metadata for the work that may also be stored in the archives 26 (step 60g). The particular metadata that is requested is controlled by the original output request and by the style sheet and transform matrix templates.

In accordance with the invention, the transform module 64 then combines the work with the text metadata as specified by the templates, converts the work from the internal format to the required intermediate format (step 60h) (e.g. HTML, RTF, text, etc. . . . ), and informs the control module 62 that the intermediate file(s) are ready in step 60i. In step 60j, the control module 62 requests form metadata from the archives 26 and the form metadata is delivered to the various output modules in step 60k. Once a module has the ready-to-process intermediate stages(s) of the work as well as appropriate module-specific metadata, the control module 62 triggers each output module (converter 1, converter 2, . . . , converter n in this example) in step 601 to process the inputs which results in one or more copies of the work (step 60m) in one or more final file formats (format 1, format 2, . . . , format n in this example) that are one or more editions. The output module list is extensible; at any time, a new module can be added to the set to support another new or different format. The extensibility of the system may enable the re-converting of previously processed work sets into the newly supported formats. Now, the output conversion in accordance with the invention will be described in more detail.

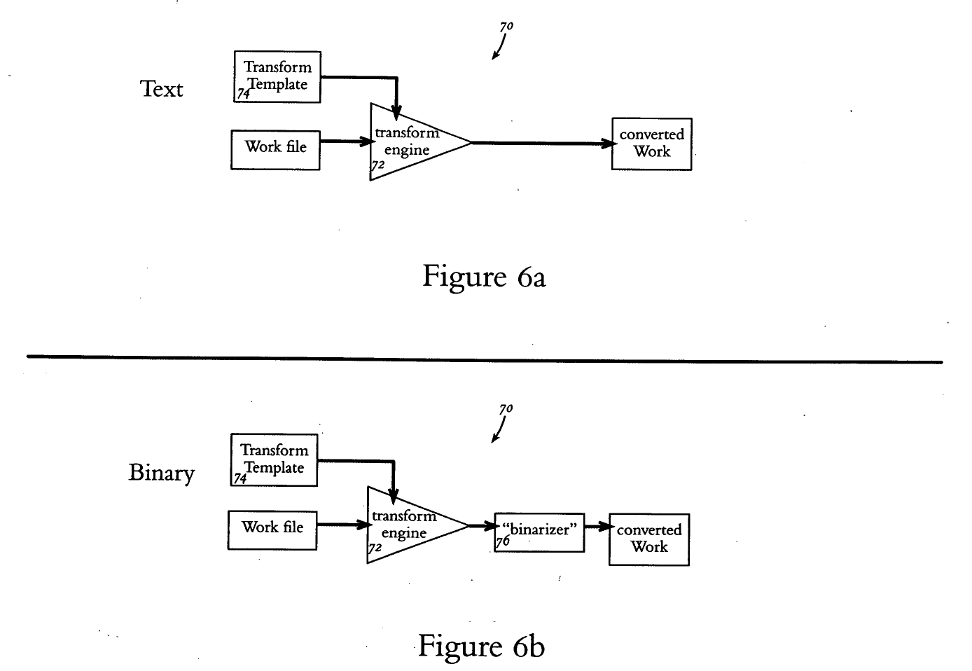

FIGS. 6A and 6B are diagrams illustrating a conversion process 70 for a text file and a binary text, respectively. In particular, whether an output format is text (i.e., a file that conforms to a standard text file format, e.g. ASCII, ISO Latin-1, Unicode) or a binary file (e.g. PalmDoc, Microsoft Reader aka “dot Lit”, Adobe Acrobat aka PDF), the output conversion 70 starts with a textual transform (using a transform engine 72) according to a transform template 74 or a conversion guide. If the target format is text, the conversion will normally be complete at that point as shown in FIG. 6A. Many formats, however, exist as binary files. Most of these have specific tools or programs available to create the target file, and it is common for them to have individual specific expectations as to the formatting and preparation of the input file. In this case, the text transform creates an appropriately formatted file (or files) for a “binarizer,” 76 or application/tool that creates the final binary format, and then the binarizer is invoked against that file or files to create the final target file(s).

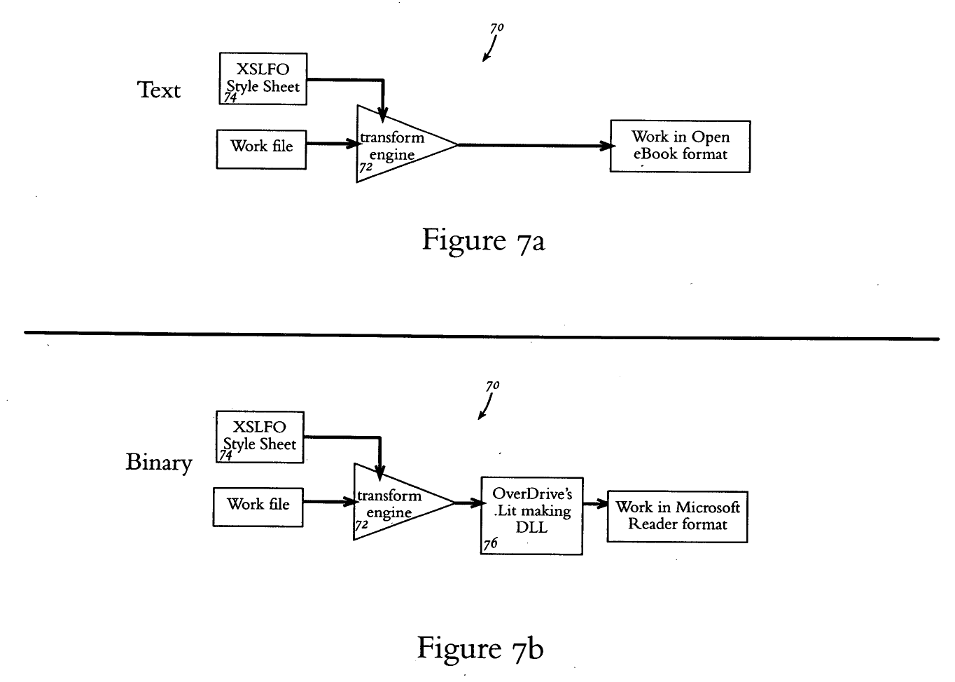

FIGS. 7A and 7B illustrate examples of the conversion process 70 for a text file and a binary file, respectively. In FIG. 7A, an Open eBook version of a work set is created while FIG. 7B illustrates a Microsoft Reader edition being generated. The Open eBook standard is a text file, specifically an XML DTD, so the transform engine can simply apply an XSLFO transformation 74 (a known XSLFO style sheet) to the work Set to create the Open eBook file set edition. The Microsoft Reader reads binary eBook files, so to create such a file, a suitably prepared (via the transform) file set is then passed to OverDrive's MSReader-creating DLL 76, which assembles the text, table of contents, and cover image into a single “dot lit” file.

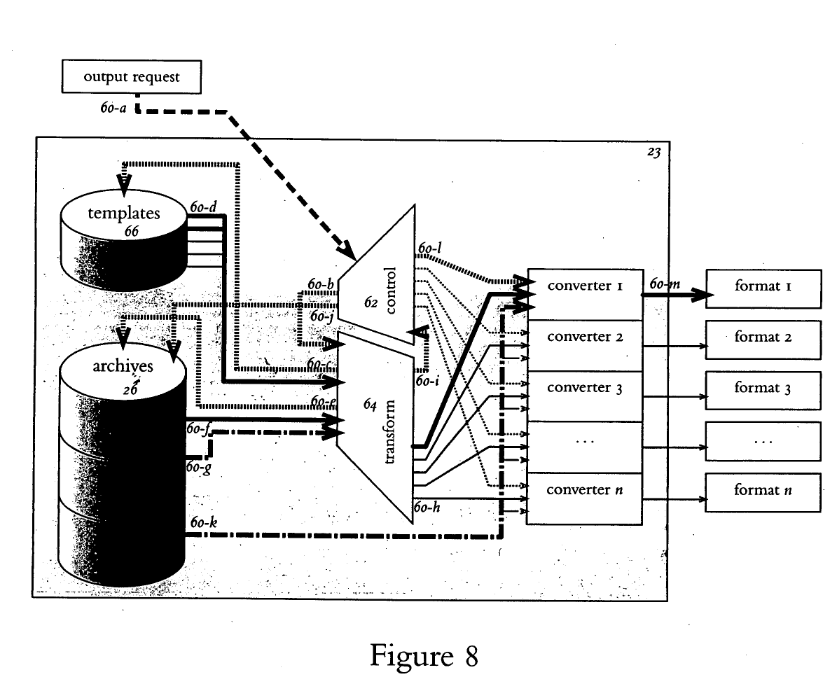

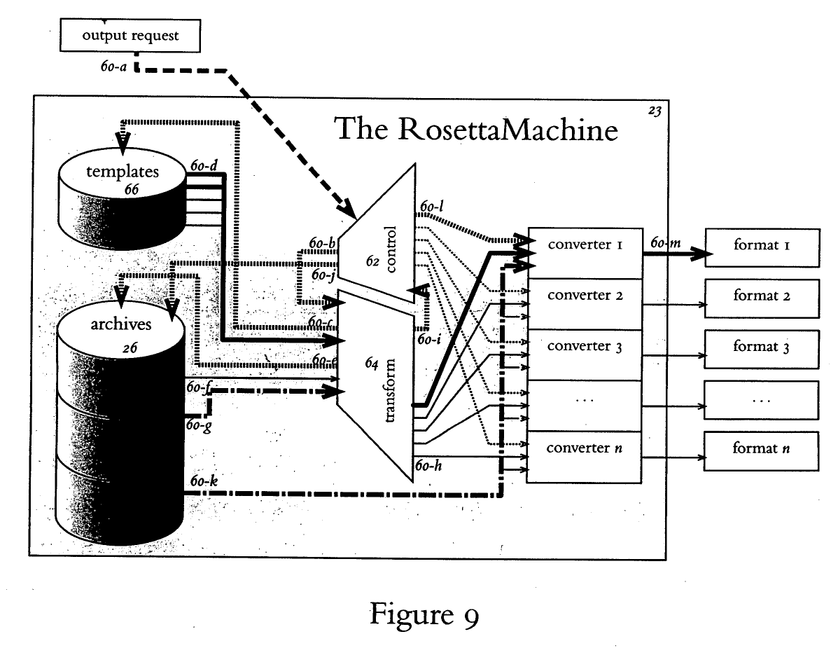

The document collection and conversion method may be easily adapted to a variety of different scenarios. For example, a request might be for a single insubstatiation of a Work (See FIG. 8), that is, a single Edition or even a single copy. FIG. 8 illustrates the same steps as shown in FIG. 5. The differences from FIG. 5 are at steps 60d, 60h, 60l, and 60m, where fewer channels are activated as only a single output format is being output. In accordance with the invention, it is also possible to request an Edition which does not actually contain the work itself, but only metadata information (See FIG. 9). This might be for a catalog entry for the Work, or pre-release information, or an advertisement, for example. In this example, the change from FIG. 5 is that step 60f is not used.

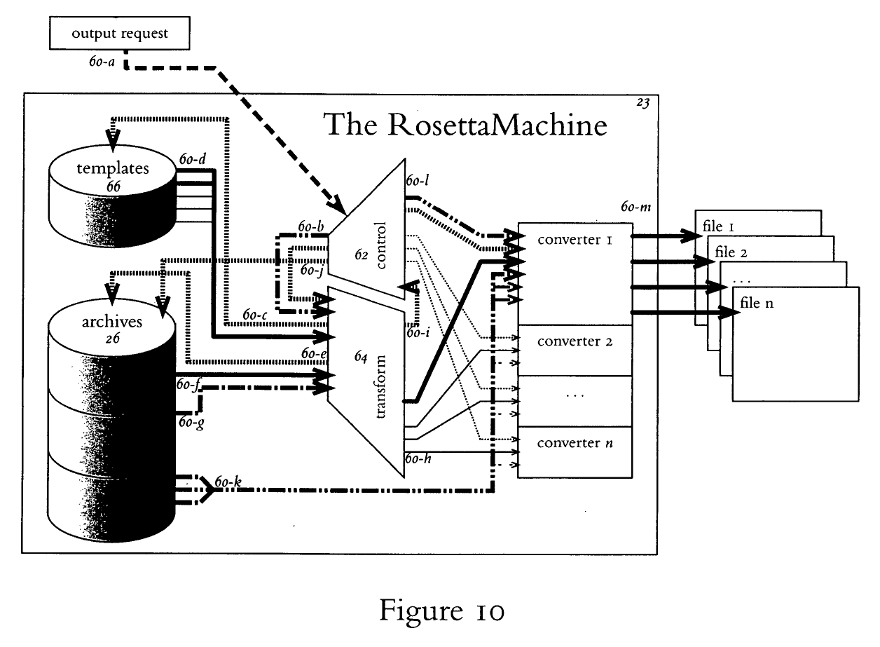

FIG. 10 illustrates the output process 23 for multiple files. In particular, the system 20 can also create multiple unique files (file 1, file 2, . . . , file n in this example) within a format since the files are all being generated by the same converter (converter 1). This diagram also makes explicit the fact that metadata may be carried in the initial request in step 60a. Steps 60b and 60l have a separate metadata channel illustrated in this figure, although the same process can occur in any of the previous output examples (FIGS. 5, 8, 9), but was omitted for clarity. Step 60k also calls out the possibility of multiple final files requiring multiple unique data feeds from the form metadata archives. Put another way, the fact that the RosettaMachine has n output modules does not restrict it to n Editions of a Work.

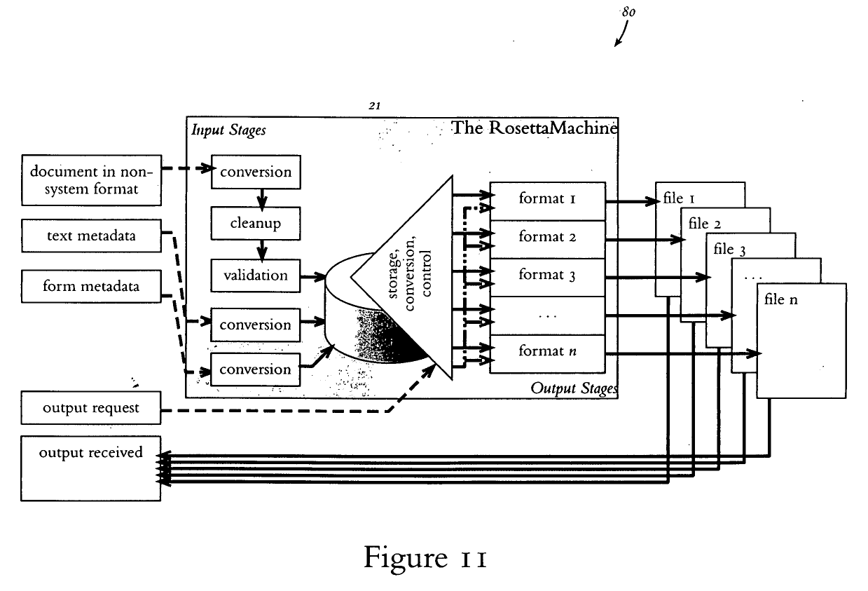

FIG. 11 illustrates an express publishing system 80 in accordance with the invention that may include the RosettaMachine 21. A basic expression of these expanded functions is the scenario where a single user inputs a work and receives multiple copies of that file in various formats as shown in FIG. 11. This version of the process is commonly used by individuals who want to post their work on their own web site; by publishers who intend to retail the work from their own website; and by publishers who already have established distribution channels, but are looking for a more painless way to handle the conversion.

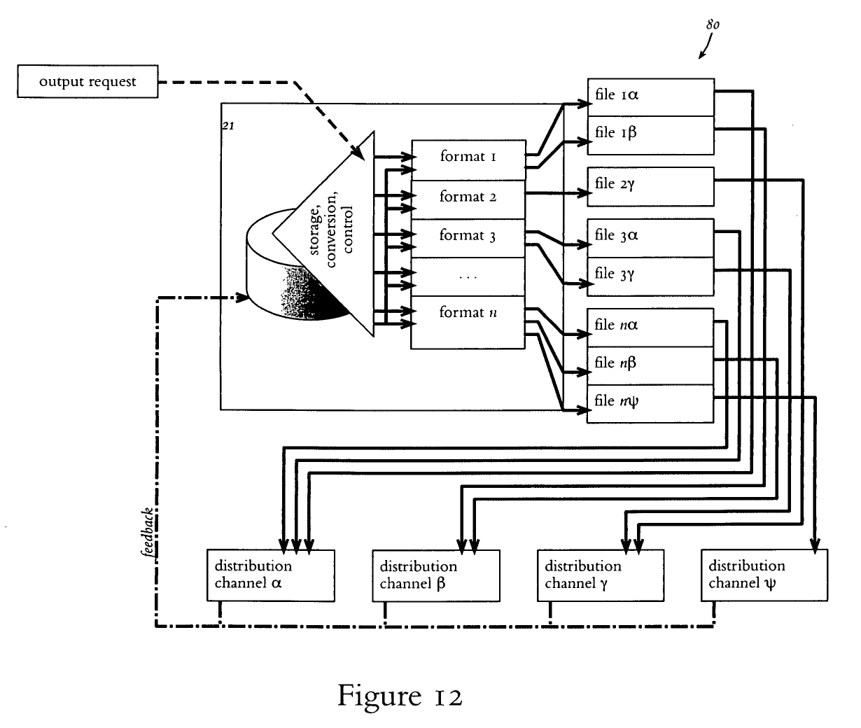

In accordance with the invention, taking advantage of the multiple editions within the same format” capability shown in FIG. 10, the user can have similar editions of the work prepared and delivered to different distribution channels as shown in FIG. 12. Examples of some of these channels would include Amazon.com; a publisher's own web site; Books-In-Print (using the metadata-only output option); an internal corporate web site; a manufacturing facility which would create physical paper books from the file; an email distribution list; and so on. The final form of the work itself could be identical within formats—the differentiating characteristics of the editions could be entirely in the accompanying metadata (e.g. distributor-specific items like a thumbnail cover image to a specified size, a distributor's discount schedule, and/or content summaries in varying languages). FIG. 12 illustrates a feedback component of the system 80. In accordance with the invention, the distributors (i.e. any external third-party) return information related to the work back to the system (e.g. number of copies sold, sale price, geographic distribution, demographics of final users) which can be used to influence subsequently produced editions of that work and/or reported back to the creator of the work.

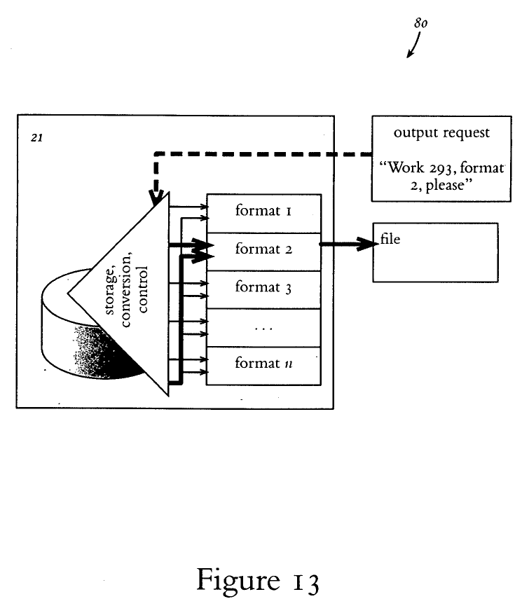

FIG. 13 illustrates the system 80 having an on demand reader-initiated mode in accordance with the invention. In accordance with the invention, the output process can just as easily be initiated by the final recipient, or end-user, of the work as by the creator, resulting in a “pull,” or on-demand conversion and distribution system. In this scenario, a buyer selects a work and a format from a catalog, and purchases the work. The system creates a unique copy of the work in the buyer's chosen format, optionally with customization such as the buyer's name or other information embedded in the work itself. This is also an example of an application for the single-file conversion option illustrated by FIG. 5.

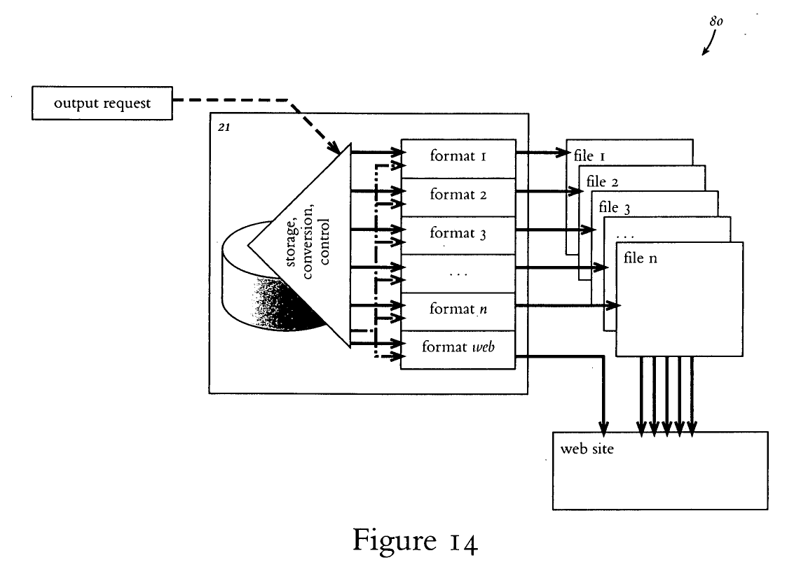

Another specific example of the utility and flexibility of the publishing system 80 is as a core of a BookGalley service shown in FIG. 14. In this example, copies of a work in various formats are embedded in a web site (or sub-site) providing access (paid or free) to either a restricted list or to the public at large (depending on how the user elects to present the work). The information on the web pages includes metadata stored in the archives. Thus, a web page, or web site, is just another edition of a work.

In accordance with the invention, the user of the system may access the systems described above using various computing devices, such as a personal computer as described above, a wireless device, a PDA, a cellular phone, a desktop system or any other computer device with sufficient computing power to access the system and interact with the system using, for example, a browser or other application. In FIGS. 11-14, the output from the publication system may be supplied to a wired or wireless computing device. Thus, for example, the output file may be provided to a cellular phone (that has the appropriate capabilities to download and then display the eBook file or to download the file and then transfer it to a different device). In addition, the output file may be output over a wired communications link (such as a computer network or cable) or a wireless link (such as over a Bluetooth link, 802.11 link, cellular phone network, etc. . . . ).

While the foregoing has been with reference to a particular embodiment of the invention, it will be appreciated by those skilled in the art that changes in this embodiment may be made without departing from the principles and spirit of the invention, the scope of which is defined by the appended claims.

1. A system for collecting and distributing an edition of a work, comprising:
an input module that receives an input file in a particular format, the input module further comprising a module that validates the input file and converts the input file into an intermediate format file;
a storage device comprising a storage portion that stores the intermediate format file and a storage portion into which a piece of work metadata associated with the input file is stored; and
a conversion module that generates one or more editions of a work having one or more formats, the one or more editions of the work being generated based on the intermediate format file and the work metadata.

2. The system of claim 1, wherein the storage device further comprises a storage portion that stores a piece of form metadata associated with the intermediate format file, the form metadata specifying a form of an edition of the work.

3. The system of claim 1 further comprising a distribution module that distributes the one or more editions of the work.

4. The system of claim 3, wherein the distribution module further comprising a plurality of distribution channels wherein each distribution channel receives a different edition of the work.

5. The system of claim 3, wherein the distribution module further comprises a web site into which the one or more editions of the work are loaded wherein the one or more editions of the work are available for download from the web site.

6. The system of claim 3, wherein the distribution module distributes the one or more editions of the work to a wireless device.

7. The system of claim 3, wherein the distribution module distributes the one or more editions of the work over a Bluetooth communications link.

8. The system of claim 1 further comprising a template storage device that stores one or more templates that transform the intermediate format file into an edition of the work.

9. The system of claim 8, wherein the template further comprises an XSLFO style sheet.

10. The system of claim 1, wherein an edition of the work further comprises an edition containing a subset of the work metadata associated with the intermediate format file.

11. The system of claim 1 further comprising a module that collects feedback about the editions of the work that are stored in the storage device.

12. The system of claim 11, wherein the feedback for an edition further comprises one or more of a number of copies of an edition sold, a sales price of an edition, a geographic distribution of the edition and a demographics of final users of the edition.

13. A computer implemented method for collecting and distributing an edition of a work, comprising:
receiving an input file in a particular format;
validating the input file;
converting the input file into an intermediate format file; and
generating one or more editions of a work having one or more formats, the one or more editions of the work being generated based on the intermediate format file and a work metadata.

14. The method of claim 13 further comprising storing the intermediate format file, work metadata and a piece of form metadata associated with the intermediate format file, the form metadata specifying a form of an edition of the work.

15. The method of claim 13 further comprising distributing the one or more editions of the work.

16. The method of claim 15, wherein the distribution further comprising providing an edition of the work to a plurality of distribution channels wherein each distribution channel receives a different edition of the work.

17. The method of claim 15, wherein the distribution further comprises providing the editions to a web site wherein the one or more editions of the work are available for download from the web site.

18. The method of claim 15, wherein the distribution further comprises distributing the one or more editions of the work to a wireless device.

19. The method of claim 15, wherein the distribution further comprises distributing the one or more editions of the work over a Bluetooth communications link.

20. The method of claim 13 further comprising storing one or more templates that transform the intermediate format file into an edition of the work.

21. The method of claim 20, wherein the template further comprises an XSLFO style sheet.

22. The method of claim 13, wherein an edition of the work further comprises an edition containing a subset of the work metadata associated with the intermediate format file.

23. The method of claim 13 further comprising collecting feedback about the editions of the work that are stored in the storage device.

24. The method of claim 23, wherein the feedback for an edition further comprises one or more of a number of copies of an edition sold, a sales price of an edition, a geographic distribution of the edition and a demographics of final users of the edition.

25. A system for collecting and distributing an edition of a work, comprising:
means for receiving an input file in a particular format, the receiving means further comprising means for validating the input file and means for converting the input file into an intermediate format file;
a storage device comprising means for storing the intermediate format file and means for storing a piece of work metadata associated with the input file; and
means for generating one or more editions of a work having one or more formats, the one or more editions of the work being generated based on the intermediate format file and the work metadata.

26. The system of claim 25, wherein the storage device further comprises means for storing a piece of form metadata associated with the intermediate format file, the form metadata specifying a form of an edition of the work.

27. The system of claim 25 further comprising means for distributing one or more editions of the work.

28. The system of claim 27, wherein the distribution means further comprising a plurality of distribution channels wherein each distribution channel receives a different edition of the work.

29. The system of claim 27, wherein the distribution means further comprises a web site into which the one or more editions of the work are loaded wherein the one or more editions of the work are available for download from the web site.

30. The system of claim 27, wherein the distribution means distributes the one or more editions of the work to a wireless device.

31. The system of claim 27, wherein the distribution means distributes the one or more editions of the work over a Bluetooth communications link.

32. The system of claim 25 further comprising means for storing one or more templates that transform the intermediate format file into an edition of the work.

33. The system of claim 32, wherein the template further comprises an XSLFO style sheet.

34. The system of claim 25, wherein an edition of the work further comprises an edition containing a subset of the work metadata associated with the intermediate format file.

35. The system of claim 25 further comprising means for gathering feedback about the editions of the work that are stored in the storage device.

36. The system of claim 35, wherein the feedback for an edition further comprises one or more of a number of copies of an edition sold, a sales price of an edition, a geographic distribution of the edition and a demographics of final users of the edition.
